(19) United States
(12) Patent Application Publication
(10) Pub. No.: US 2026/0093918 A1
(43) Pub. Date: Apr. 2, 2026

(54) SYSTEMS AND METHODS FOR A NEURAL NETWORK LANGUAGE MODEL

(71) Applicant: Salesforce, Inc., San Francisco, CA (US)

(72) Inventors: Shafiq Rayhan Joty, San Jose, CA (US); Xuan Phi Nguyen, Singapore (SG); Yifei Ming, Palo Alto, CA (US); Zixuan Ke, Palo Alto, CA (US)

(21) Appl. No.: 19/043,118

(22) Filed: Jan. 31, 2025

Related U.S. Application Data
(60) Provisional application No. 63/701,382, filed on Sep. 30, 2024.

(51) Int. Cl. G06F 40/284; G06N 3/084

(52) U.S. Cl. CPC G06F 40/284; G06N 3/084

(57) ABSTRACT

Embodiments described herein provide a multi-stage training and/or post-training framework to train and/or finetune a GLLM for domain-specific tasks so as to build an AI agent in a variety of technical applications. Specifically, the training framework comprises a first stage of combined continual pretraining (CPT) and instruction tuning (IT), and a second state of preference training.

### CROSS REFERENCE(S)

This application is a nonprovisional of and claims priority to U.S. provisional application No. 63/701,382, filed Sep. 30, 2024, which is hereby expressly incorporated by reference herein in its entirety.

This application is related to co-pending U.S. nonprovisional application Ser. No. ______ (attorney docket no. 70689.381US02), filed on the same date, which is hereby expressly incorporated by reference herein in its entirety.

### TECHNICAL FIELD

The embodiments relate generally to machine learning systems for artificial intelligence (AI) language processing, and more specifically to training a general-purpose neural network language model.

### BACKGROUND

AI agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

For example, general-purpose large language models (GLLMs) like GPT-4 and LLaMA may be configured to perform a wide range of natural language tasks such as summarization, question answering, machine translation, and/or the like. However, such GLLMs often falls short in domain-specific or task-specific applications, where deeper, specialized knowledge is needed.

### BRIEF DESCRIPTION OF THE DRAWINGS

FIG. 1 shows an application of an LLM based AI agent, according to embodiments of the present disclosure.

FIG. 2A is a simplified diagram illustrating example data characteristics of curated texts of a target domain for finetuning an LLM, according to embodiments described herein.

FIG. 2B is a simplified diagram illustrating a multi-stage training framework for LLM shown in FIG. 1, according to some embodiments.

FIGS. 3A and 3B provide two simplified diagrams illustrating example data generation pipelines for generating reasoning trajectories, according to some embodiments.

FIG. 4 is a simplified diagram illustrating a computing device implementing the training framework described in FIG. 1-3B, according to some embodiments.

FIG. 5 is a simplified diagram illustrating a neural network structure, according to some embodiments.

FIG. 6 is a simplified block diagram of a networked system suitable for implementing the training framework described in FIGS. 1-3 and other embodiments described herein.

FIG. 7 is an example logic flow diagram illustrating a method of building an artificial intelligence (AI) agent using a neural network based language model using training pipelines shown in FIGS. 1-3B, according to some embodiments described herein.

FIG. 8 is an example logic flow diagram illustrating a method of building an artificial intelligence (AI) agent using a neural network based language model using training pipelines shown in FIGS. 1-3B, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

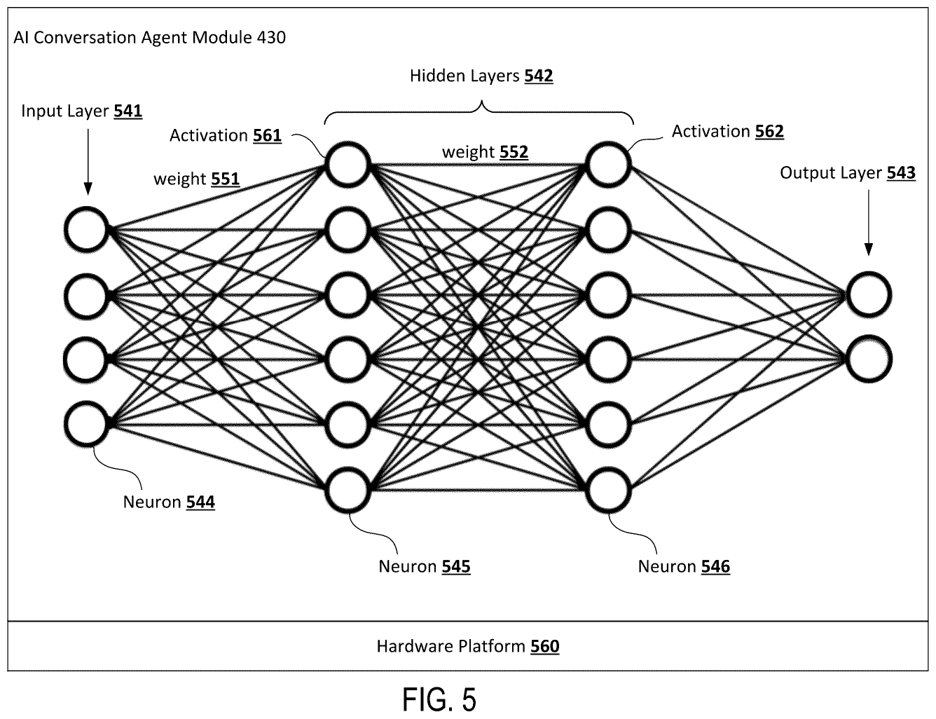

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

AI models such as general-purpose large language models (GLLMs) like GPT-4 and LLaMA may be configured to perform a wide range of natural language tasks such as summarization, question answering, machine translation, and/or the like. Domain-adaptive post-training may be implemented to further train or finetune GLLMs with domain-specific data and/or in specialized tasks, such as generating diagnostic reports based on medical imaging, grading examination papers, and/or the like. However, significant challenges remain in identifying optimal adaptation criteria and training strategies across varying data and model configurations. In addition, fine-tuning GLLMs on each domain or task specific dataset can be computationally expensive and inefficient.

Embodiments described herein provide a multi-stage training and/or post-training framework to train and/or finetune a GLLM for domain-specific tasks so as to build an AI agent in a variety of technical applications. Specifically, the training framework comprises a first stage of combined continual pretraining (CPT) and instruction tuning (IT), and a second state of preference training.

In one embodiment, the first stage comprises a joint training framework that trains an LLM using continual pretraining (CPT) and instruction tuning (IT) simultaneously. Specifically, a CPT dataset is formed including plain text samples so as the LLM receives the training sample to predict a next token which reconstructs the input. An IT dataset may comprise an input, a response and an instruction (e.g., to “summarize the input text,” to “solve the problem described by the input”) to generate the response. The CPT and the IT dataset may be mixed with a hyperparameter as the mixture ratio such that the CPT data is down-sampled to match the size of the IT dataset. In this way, at each training iteration, the LLM receives a training sample randomly selected from the CPT-IT mixed dataset, and generate a training output, e.g., depending on whether the selected training sample is CPT or IT sample.

For example, the CPT dataset may train the LLM on the background knowledge from unsupervised raw text, while IT dataset may finetune the LLM on supervised task knowledge such as question answering, summarization, rewrite, and/or the like. Instead of naively training sequentially with specialized data, the combined CPT and IT training may combine general and domain-specific data such that knowledge learnt from one dataset (CPT) will not be lost during the finetuning using the IT dataset.

In one embodiment, CPT and IT may be jointly implemented with appropriate mixture ratio to mitigate stage-specific knowledge. Domain-specific data may be mixed with general data to mitigate general knowledge forgetting.

In one embodiment, the second stage comprises a training framework that trains an LLM to generate a reason of a specific output using preference learning. Specifically, given a question and a solution from a training dataset, an LLM is used to generate a reasoning path that leads to the solution, and a binary preference whether the solution is correct. The resulting training sample comprises the question, the solution and the binary preference (correct or incorrect) may be used for preference training the LLM. Additionally, the LLM may generate a binary preference for each step along the reasoning path to as to form a training sample comprising the question, the reasoning path up to the first error step, and a newly generated correct step, and the error step for preference training the LLM.

The multi-stage training framework may result in an efficient LLM adapted with specific domain knowledge, e.g., an LLM (Llama-Fin) adapted for the finance domain at the 8b parameter scale. In this way, with improved performance on training LLMs on specific tasks or domains, neural network technology in building an AI conversation and/or knowledge agent is improved.

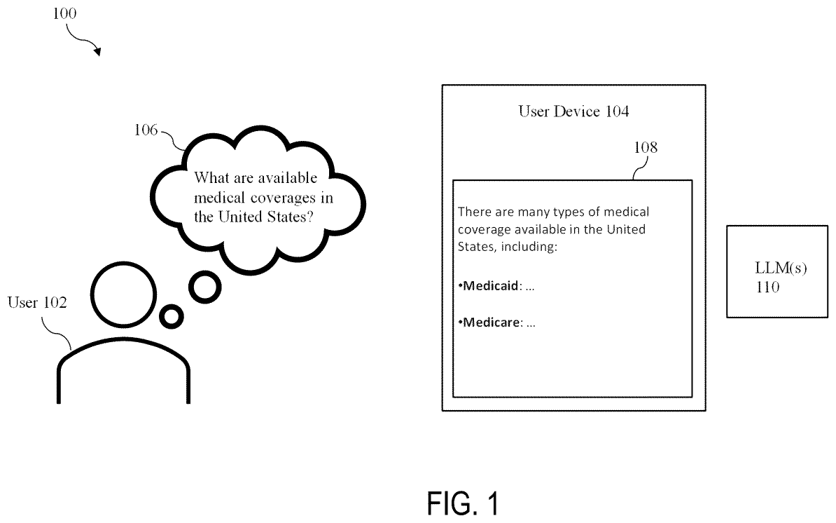

FIG. 1 shows an application 100 of an LLM based AI agent, according to embodiments of the present disclosure. A user 102 may utter or enter a query 106 in natural language. In response, a user device 104 may output/display an answer 108 on a display interface, such as a screen. In some embodiments, answer 108 is the output of an artificial intelligence (AI) agent, which is built on a bot server that is communicatively connected to user device 104. The AI agent may be based on, or include, an LLM. In some embodiments, the LLM receives query 106 through utterance of user 102, which may retrieve a corpus of documents, and generate an output based on the retrieved documents.

As an example, query 106 may include a question of “What are available medical coverages in the united states?” The AI agent may include the query 106 in a predefined format providing instruction to the LLM how to generate a response to query 106, referred to as a “prompt,” which may be fed to an LLM as input. The LLM 110 may in turn provide answer 108, e.g., a summary of the types of medical coverages in a predetermined format, e.g., a bullet-point format, such that one type of medical coverage is listed behind a bullet-point. In some aspects, for example, a citation of document(s) that mentioned the medical coverage is provided behind the respective bullet. The underlying LLM may be implemented at user device 104, or at a remote server which is accessible by the user device 104. The LLM may be trained with a large corpus of texts and/or documents to provide a user desirable response.

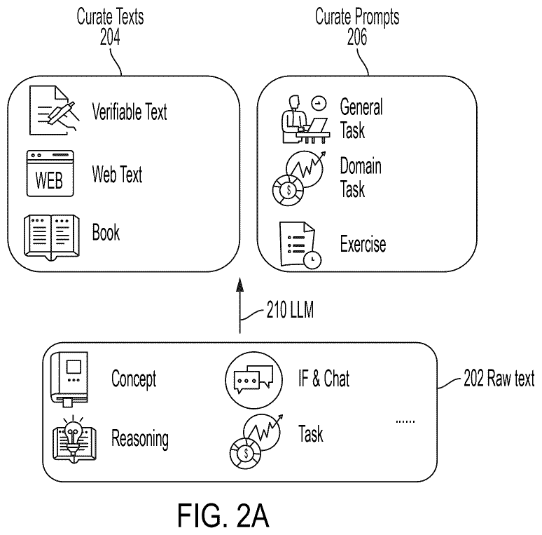

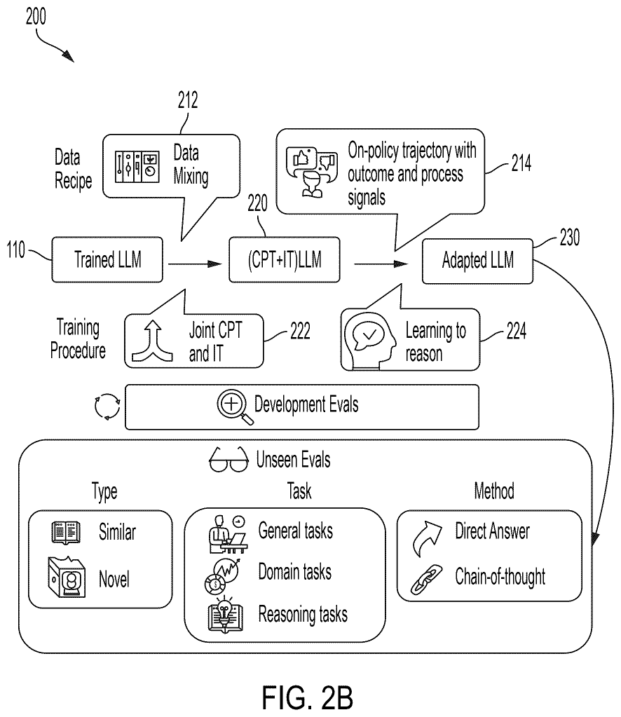

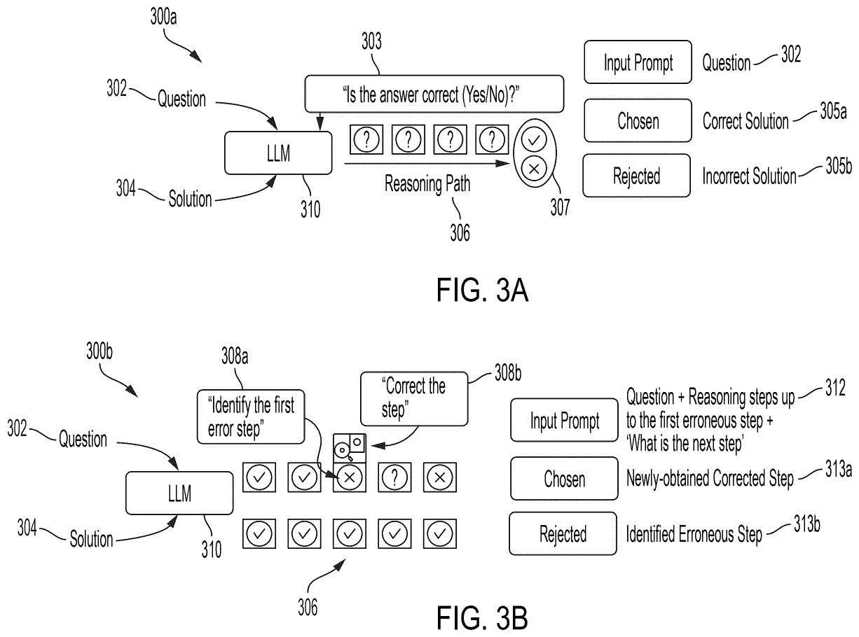

As shown in FIG. 1, LLM 110 has been queried on a domain-specific question in the domain of healthcare. LLM 110 may be finetuned using the multi-stage training framework described in FIGS. 2A-3B.

FIG. 2A is a simplified diagram illustrating example data characteristics of curated texts of a target domain for finetuning an LLM, according to embodiments described herein. For example, domain-specific data, in the form of raw text 202, may comprise domain-specific concepts, reasoning, task, chat information, and/or the like.

Domain specific concepts may refer to an idea, term, or principle that is uniquely relevant to a particular field, discipline, or area of study. For example, ‘bond’ in finance refers to a loan agreement between an investor and a borrower. Adapting the LLM to domain-specific concepts including training the LLM to understand domain knowledge such as “bond” in the context of financial documents. However, this adaptation should not come at the cost of losing knowledge about general concepts (e.g., “bond” may refer to other meaning in a different context”).

Domain specific tasks may refer to a task or activity that is explicitly tied to a particular field, discipline, or area of expertise. These tasks often require specialized knowledge, tools, or techniques unique to that domain to be performed effectively. For example, while many natural language processing (NLP) tasks, such as sentiment analysis, are shared across different domains, a domain typically has its own tasks. For example, stock movement detection is primarily found in the field of finance.

Reasoning text with concepts refers to the LLM generating explaining texts on how and why a particular answer is generated. For example, in finance, the LLM is often required to analyze a company's financial report, involving extensive reasoning, particularly mathematical reasoning, to compute key financial concepts such as market rate or earnings per share.

Instruction-Following (IF) and chat text may refer to the LLM performing task according to a specific instruction (prompt), such as summarizing data, generating guided summary, and/or the like.

Additionally, domains may vary significantly in their sensitivity. For instance, the medical domain is highly sensitive, requiring utmost accuracy and strict adherence to ethical considerations. In contrast, domains such as entertainment may have more relaxed requirements. Another important consideration is multi-modality, as some domains require handling multiple types of input and output formats. For example, the healthcare domain may involve processing medical images alongside textual reports, while the e-commerce domain may integrate product descriptions, images, and customer reviews into a unified response. Similarly, scientific research often combines charts, graphs, and textual analysis to present findings effectively.

In one embodiment, the raw text 202 may be curated and/or re-written, e.g., by an LLM 210, into curate texts 204 and/or prompts 206 for training and/or testing. Specifically, to introduce domain concepts while preserving general concepts, raw texts 202 may be curated, e.g., by LLM 210, for CPT. For example, CPT dataset may comprise a relatively small but high-quality set of general-domain text. To achieve this, verifiable text, which is text written by humans and previously used in supervised tasks in the literature, may be used. For domain concept, a large volume of data, e.g., financial texts from primarily relevant websites and books may be collected.

For example, an example prompt for an LLM to curate materials from a text book to generate curated texts for CPT may take a form similar to the following:

| | |
|---|---|
| | Below is an extract from a text book. Evaluate whether the book has a |
| | high financial value and could be useful in an financial setting for teaching |
| | financial students using the additive scoring system described below. Points |
| | are accumulated strictly based on the satisfaction of each criterion: |
| | - Add 1 point if the extract provides educational value for financial students |
| | whose goal is to learn financial concepts or take finacial exams. It is |
| | acceptable if quizzes are not included; however, if quizzes are present, |
| | detailed solutions and explanations must also be provided |
| • | Add 1 point if the extract provides educational value for financial students |
| | whose goal is to learn financial concepts or take financial exams. It is |
| | acceptable if quizzes are not included; however, if quizzes are present, |
| | detailed solutions and explanations must also be provided. |
| • | Add another point if the extract addresses certain elements pertinent to |
| | finance and aligns closely with financial standards. It might offer a superficial |
| | overview of potentially useful topics or present information in a disorganized |
| | manner and incoherent writing style. |
| • | Award a third point if the extract is appropriate for financial use and introduces |
| | key concepts relevant to financial curricula. It is coherent and |
| | comprehensive. |
| • | Grant a fourth point if the extract is highly relevant and beneficial for |
| | financial learning purposes for a level not higher than financial students, |
| | exhibiting a clear and consistent writing style. It offers substantial financial |
| | content, including exercises and solutions, with minimal irrelevant |
| | information, and the concepts aren't too advanced for financial students. The |
| | content is coherent, focused, and valuable for structured learning. |
| • | Bestow a fifth point if the extract is outstanding in its financial value, |
| | perfectly suited for teaching either at financial students. It follows detailed |
| | reasoning, the writing style is easy to follow and offers profound and |
| | thorough insights into the subject matter, devoid of any non-financial or |
| | complex content. |
| | The extract: <EXAMPLE>. |
| | After examining the extract, You will output a json object containing the |
| | following 2 fields: |
| | { |
| ” | Justification ″: string // Briefly justify your total score , up to 100 |
| | words . |

” Score ″: integer // Conclude with thescore}

In one embodiment, prompts 206 may be curated to represent the diverse ways users may interact with models and serves the essential component for instruction tuning (IT) and/or preference alignment (PA). For example, a broad survey and source general, financial, instruction-following, and reasoning tasks may be curated from public datasets. Curated prompts 206 may also comprise reasoning tasks as they usually involve challenging reasonings and come with ground truth answers and sometimes even include human-written chain-of-thought (CoT) explanations. For example, an example prompt for an LLM to extract exercise from a text book may take a form similar to the following:

| | |
|---|---|
| | You are an educational assistantaims to extract all questions from the provided |
| | material. Look for specific indicators such as ″example,″ ″quiz,″ ″questions,″ |
| | or similar terms to identify where the questions are located. If the material |
| | includes scenarios or exhibits, must include all details related to them. Do not |
| | create or derive any questions or come up with content on your own— |
| | strictly extract what is present in the material. Make sure no question is |
| | missed. If one scenario or exhibits corresponds to multiple questions, |
| | duplicate the scenarios and exhitbits so that the number of questions match |
| | the number of scenarios and exhibits. |
| | The material: <MATERIAL>. |
| | After performing these tasks, You will output a json object containing |
| | the following fields: |
| | { |
| ” | Justification ″: ″ string ″, // A brief justification for your extractions, |
| | up to 100 words . |
| ” | Questions ″: ″ string ″, // A list of questions extracted from the |
| | material . Only extract the exact questions presented in the text. |
| ” | Scenario ″: ″ string ″, // A list of scenarios corresponding to the above |
| | questions. |
| ” | If the material does not provide the scenario place ″ N/A.″ Do |
| | not do any derivation or reference , must output the exact same , |
| | detailed and complete scenarios . The scenario may contain multiple |
| | paragraphs or even splited by the exhibits , combine them into one |
| | string . The scenario can be long, you may modify it to make it |
| | shorter, |
| ” | but must not change its meaning . |

” Exhibit ″: ″ string ″, // A list of exhibits or tables

| | |
|---|---|
| | corresponding to the above questions . If the material does not |
| | provide the exhibit , place ″ N/ A.″ Do not do any summary , or |
| | derivation or cutting, |
| | must output the exact same , detailed and complete exibits . There |
| | may be multiple exhibits involved in a scenario , combine them into |
| | one string . The exhibit can be long , you may modify it to make it |
| | shorter . Must keep the table format |
| | Answer Choices ″: ″ string ″, // A list of answer choices corresponding |
| | to the above questions . If the material does not provide answer |
| | choices , place ″ N/A.″ |
| ” | Answer ″: ″ string ″ // A list of answers corresponding to the above |
| | questions . Answers should only be included if provided in the |
| | material . If no answer is given , place ″ N/ A.″ If explanations or |
| | reasoning steps or equations are included , |
| | must capture all of them . Must not answer it yourself if there is no |
| | answer provided in the material . Make sure the final number of |
| | questions equals to number of scenario equals to number of exhibits |
| | equals to number of answers |

FIG. 2B is a simplified diagram illustrating a multi-stage training framework 200 for LLM 110 shown in FIG. 1, according to some embodiments. As shown in FIG. 2B, a pretrained LLM 110 (pretrained with generic non-domain specific text data) may further go through a multi-stage training procedure. For example, the trained LLM 110 may further be trained and/or finetuned with a dataset 212 mixed with non-domain specific text data and domain specific text data (e.g., healthcare, finance, etc.).

In one embodiment, at the first stage of training, a joint CPT and IT training procedure may be adopted using the mixed dataset 212. For example, for CPT, a text sample may be randomly drawn from the mixed dataset 212 and fed to LLM 110, which in turn perform next token prediction to reconstruct the input text sample. Example training tasks for CPT may include masked language modeling (MLM), e.g., the LLM 110 to predict masked-out tokens in the input text sample based on the context of the text sample; causal language modeling (CLM), e.g., the LLM 110 to predict the next word in the text sample given the previous words in the text sample; text infilling, e.g., the LLM 110 to predict missing spans of text in the text sample; permutation language modeling (PLM), e.g., the LLM 110 to predict tokens in a randomly permuted order rather than a strict left-to-right or bidirectional manner, and/or the like.

In one implementation, for example, CPT may be performed using non-domain specific text sample from the mixed dataset 212. For instance, a text sample of “The cat sat on the mat” may be randomly sampled, and thus an input of “The cat sat on the [MASK]” may be fed to LLM 110 to predict the mased token, which is in turn compared with the masked token “mat” to generate a next token prediction loss, e.g., cross-entropy.

In one implementation, for example, CPT may be performed using domain-specific sample from the mixed dataset 212. For example, auxiliary tasks may be adopted for specific domains, such as reconstructing structured tables (e.g., in finance), predicting medical terminology expansions (e.g., abbreviations in clinical data), translating code snippets into comments (e.g., in software engineering data), and/or the like.

In some embodiments, to adapt the LLM to domain-specific and instruction following tasks, the mixed dataset 212 may comprise IT data. Specifically, the IT data sample may comprise a question, an instruction (prompt) to address the question such as summarization, translation, answering the question, and/or the like, and a response according to the instruction. The response may be generated by filtering existing responses or creating new responses by a language model such as GPT-4. For prompts without responses, for example, exercises extracted from books that may not have solutions provided, new responses may be generated using GPT-4o.

In one embodiment the trained LLM 110 may be finetuned using IT data samples under supervised learning. For example, when fed a training input from the IT data sample, the LLM 110 may predict an answer according to the instruction in the training sample. The loss objective is to minimize the difference between LLM predicted answer and the actual answer in the IT training sample. Once after IT finetuning, LLM 110 may become better at handling unseen tasks when presented in instruction-like formats, as it has learned to interpret and act on user instructions.

In some embodiments, conventional CPT applied to an instruction-tuned LLM can cause serious forgetting on instruction-following (IF) capability, or when IF is applied to a pretrained LLM can cause forgetting on general task capabilities learnt from CPT. Therefore, the training stage of joint CPT and IT 222 may be implemented using the mixed dataset 212. For example, a training sample may be randomly drawn from the mixed dataset 212, either domain-specific or non-domain specific. The training sample may be alternately, randomly, or depending on the content of the training sample (e.g., whether it is an IT training sample) used for CPT and/or IT. A training objective may combine a first loss based on CPT as discussed above, and a second loss based on IT as discussed above. For example, the training objective may be a weighted sum of the two types of training losses to update the LLM 110. Additional details of training a neural network via backpropagation may be described in relation to FIG. 5.

In some embodiments, the CPT and IT jointly trained LLM 220 may be further trained using the reasoning training procedure 224 on a reasoning dataset of policy trajectories 214. In one embodiment, Preference Alignment (PA), where the model is trained to assign higher probability mass to better generations, has been shown to be effective in enhancing reasoning capabilities of LLMs, may be adopted to further train LLM 220.

Specifically, reasoning training 224 may adopt Direct Preference Optimization (DPO), which directly learns from positive (chosen) and negative (rejected) preference data. For example, a training sample for preference alignment from the dataset of trajectories 214 may comprise a training input, a negative output (not preferred) and a positive output (preferred). The LLM 220 may be trained to generate an output that “aligns” with the positive output, deviates away from the negative output. For example, a loss objective may be computed as a difference between the logits corresponding to the positive output and a logit corresponding to the negative output, and such difference is to be maximize so that the positive output is ranked higher than the negative output.

Other examples of loss objectives for PA training may comprise a sigmoid function over the difference between the positive logit and the negative logit, a margin-based ranking loss max (0, m−(s₊−s₋)) where s₊ and s₋ represent the logits respectively such that the loss encourages s₊ to be greater than s₋ for at least m.

In one embodiment, the policy trajectories dataset 214 may be generated from an on-policy model, i.e., the jointly trained CPT+IT LLM 220. FIGS. 3A and 3B provide two simplified diagrams illustrating example data generation pipelines for generating reasoning trajectories for the dataset 214.

Data generation pipeline 300a uses a GLLM 310, such as GPT-4o as a generative outcome reward model to give a reward to a solution 304 to a question 304. For example, given a prompt 302 and a candidate model generated solution 304, LLM 310 may be fed a prompt 303 to give a holistic judgment 307 for the entire solution 304, generating an output of a single ‘Yes’ or ‘No’ token 307. The reasoning path 306 on how the solution 304 is arrived at remain largely invisible. An example prompt 303 for the GLLM 310 to give a binary reward 307 to the solution 304 may take a form similar to the following:

| | |
|---|---|
| | You given a question, a reference answer and a proposed answer, you task is to |
| | determine the correctness of the proposed answer. First, extract the final |
| | answer (for example, A, B or C) from the reference answer. Second, extract |
| | the final answer from the proposed answer (for example, A, B or C). Finally, |
| | compare the two final answer to determine the correctness. Do not do any |
| | extra reasoning, must determine the correctness soley based on the given |
| | reference and proposed answer. |
| | Question: <QUESTION> Reference Answer: <REFERENCE> Proposed |
| | Answer: <PROPOSAL> |
| | After performing these tasks, You will output a json object containing the |
| | following fields: |
| | { |
| ” | Justification ″: ″ string ″, // A brief justification for your output, |
| | up to 100 words . |
| ” | Correctness ″: ″ string ″, // If the proposed answer has the same final |
| | final answer as the reference answer ( for example , both choose A or |
| | have the same answer), |
| ” | output ′correct′. |
| ” | Put ′ wrong ′ to all other cases . For example , if the proposed answer |
| | has a different final answer comparing to the reference answer , |
| | put ′ wrong ′. If the proposed answer does not explicitly give a final |
| | answer to the question , put ′ wrong′. |
| | If the proposed answer gives more than one final answer to the |
| | question, put ′wrong′. |

Here, a preference alignment training sample may be constructed comprising the question 302, a correct solution 305a (a solution that is marked as “yes” by token 307), and/or an incorrect solution (e.g., a solution that is marked as “no” by token 307).

Data generation pipeline 300b uses the GLMM 310, such as GPT-4o, as a generative outcome reward model to give a reward to the process along a reasoning path 306 that leads to the solution 304 to the question 304. Since reasoning is often complex, GLLM 310 may provide process rewards along a reasoning path 306. Instead of requesting rewards at each step of reasoning path 306, GLLM 310 may be provided a prompt comprising a first instruction 308a to identify the first erroneous step in the reasoning path, and a second instruction 308b to correct the erroneous step. In one implementation, the instructions 308a and 308b may be combined into a single prompt for the GLLM 310 to generate the reasoning path 306 comprising a series of steps that lead to the solution 304, an identified erroneous step, and a corrected step in one inference. In another implementation, the GLLM 310 may first generate the reasoning path 306 based on an input of the question 302 and the solution 304. Then the GLMM 310 may be fed the instructions 308a and/or 308b to generate the identified erroneous step, and the corrected step in one or more inference times. An example prompt for the GLLM 310 to rate the process that arrives at the solution 304 may take a form similar to the following:

Given a question, a reference answer and an incorrect answer, you task is to
identify the first incorrect step from the incorrect answer. The ″first incorrect
step″ means all reasoning up to that point is accurate, but the error begins at
this specific step.
Question: <QUESTION> Reference Answer: <REFERENCE> Incorrect Answer:
<INCORRECT>
After performing these tasks, You will output a json object containing the
following fields:
{

| | |
|---|---|
| ” | Justification ″: ″ string ″, // A brief justification for your output, |

up to 100 words .
You need to explain

| | |
|---|---|
| (1) | why the identified first incorrect step is incorrect ; |
| (2) | why the reasoning up to this specific step is correct and (3) |

how the corrected step resolves the issue, aligning with the
reference answer ,
maintaining the logical flow and progressing to the final answer .

| | |
|---|---|
| ” | First incorrect step ″: ″ string ″, // The explanation in the incorrect |

answer consists of multiple reasoning steps . Please identify the first
incorrect reasoning step . It should be a piece of text directly and
exactly quoted from the incorrect answer . It should be an
intermediate step rather than the final answer

| | |
|---|---|
| ” | Reasoning up to incorrect ″: ″ string ″, // From the incorrect |

answer , give the correct reasoning steps up to the first incorrect step
. This should be directly and exactly quoted from the incorrect
answer.

| | |
|---|---|
| ” | Step correction″: ″string″, // Replace the identified incorrect |

step with a single , clear , and correct step . This step should directly
address and correct the error , explicitly providing the correct
reasoning without requiring for more information or challenging the
question . It should effectively answer the question , ″ What is the next
reasoning step ?″ given on the question and the identified ″ Reasoning
up tp incorrect ″. It should help progress to the final answer .
}

Using this correction, a preference data sample may be constructed comprising an input prompt 312 formed by concatenating the original question 302, the candidate reasoning steps up to the first erroneous step, and a follow-up question framed as “What is the next step?”; a newly-obtained corrected step 313a as the positive answer, and the original first erroneous step 313b as a negative answer. In this way, the input prompt 312, chosen positive answer 313a and rejected negative answer 313b may produce trajectories that focus on predicting the correct next step given a reasoning prefix, rather than requiring a prediction of the entire reasoning trajectory.

Referring back to FIG. 2B, the adapted LLM 230, after preference alignment training, may be used to perform unseen tasks, e.g., with unseen instructions from users, e.g., to perform domain-specific tasks (e.g., healthcare, finance, etc.), reasoning tasks, and/or to generate a direct answer or a chain-of-though reasoning path output, and/or the like.

Then the trained LLM 230 may be evaluated by different types of tasks, e.g. similar type includes tasks whose types have been encountered during training, even if the specific tasks themselves are unseen (e.g., a new NER task), or the Novel type includes tasks whose types have not been seen during training, representing entirely new challenges for the model (e.g., stock movement prediction). Additional evaluation and data experiments of the LLM 230 may be presented below.

### Computer and Network Environment

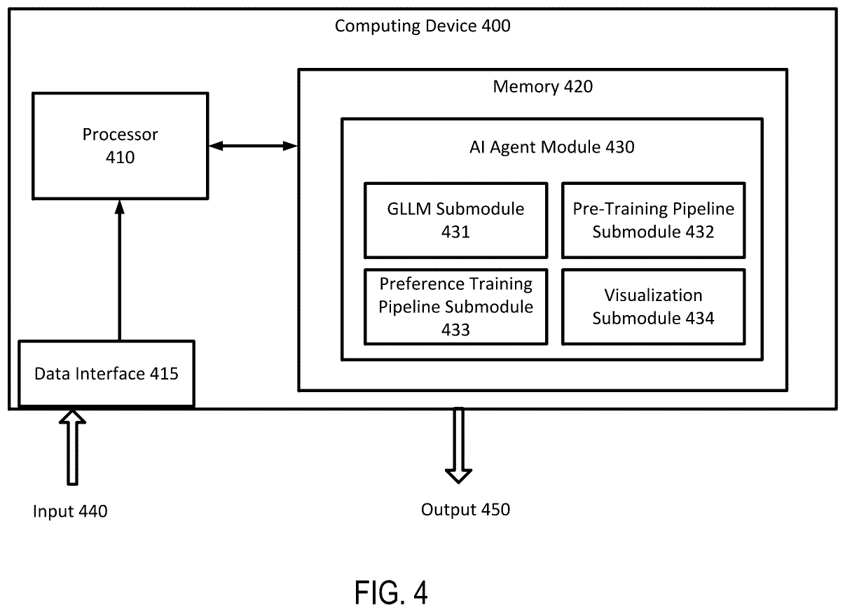

FIG. 4 is a simplified diagram illustrating a computing device implementing the training framework described in FIG. 1, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI conversation agent module 430 that may be used to implement and/or emulate the systems and models, and/or to implement any of the methods described further herein. AI conversation agent module 430 may receive input 440 such as an input training data (e.g., text samples) via the data interface 415 and generate an output 450 which may be a task output.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a question, from a user via the user interface.

In some embodiments, the AI agent module 430 is configured to generate a response to a user input. The AI conversation agent module 430 may further include GLLM submodule 431, a pre-training pipeline submodule 432 (e.g., for joint CPT and IT training at 222), a preference training pipeline submodule 433 (e.g., for preference training at 224) and a visualization submodule 434 (e.g., to cause a display at a user interface).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the AI conversation agent module 430 described in FIG. 4, according to some embodiments. In some embodiments, the AI conversation agent module 430 and/or one or more of its submodules 431-434 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5A), such as a user input question. The number of nodes (neurons) in the input layer 541 may be determined by the dimensionality of the input data (e.g., the length of a vector of a user input question). Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 4, the AI conversation agent module 430 receives an input 440 of a user input question and transforms the input into an output 450 of a response to the user input question. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI conversation agent module 430 and/or one or more of its submodules 431-434 may comprise the transformative neural network structure of layers of neurons, and weights and activation functions describing the non-linear transformation at each neuron. Such a neural network structure is often implemented on one or more hardware processors 510, such as a graphics processing unit (GPU). An example neural network may be Transformer based LLM, and/or the like.

In one embodiment, the AI conversation agent module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI conversation agent module 430 and its submodules 431-434 may be implemented by hardware, software and/or a combination thereof. For example, the AI conversation agent module 430 and its submodules 431-434 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the AI conversation agent module 530 and its submodules 531-234 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI conversation agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI conversation agent module 430 and one or more of its submodules 431-434 may be trained by iteratively updating the underlying parameters (e.g., weights 551, 552, etc., bias parameters and/or coefficients in the activation functions 561, 562 associated with neurons) of the neural network based on the loss. For example, during forward propagation, the training data such as text training samples are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding response to a training question) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based AI conversation agent module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, AI conversation agent module 430 and its submodules 431-434 may be housed at a centralized server (e.g., computing device 500) or one or more distributed servers. For example, one or more of AI conversation agent module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as tasks in specific domains.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI conversation agents.

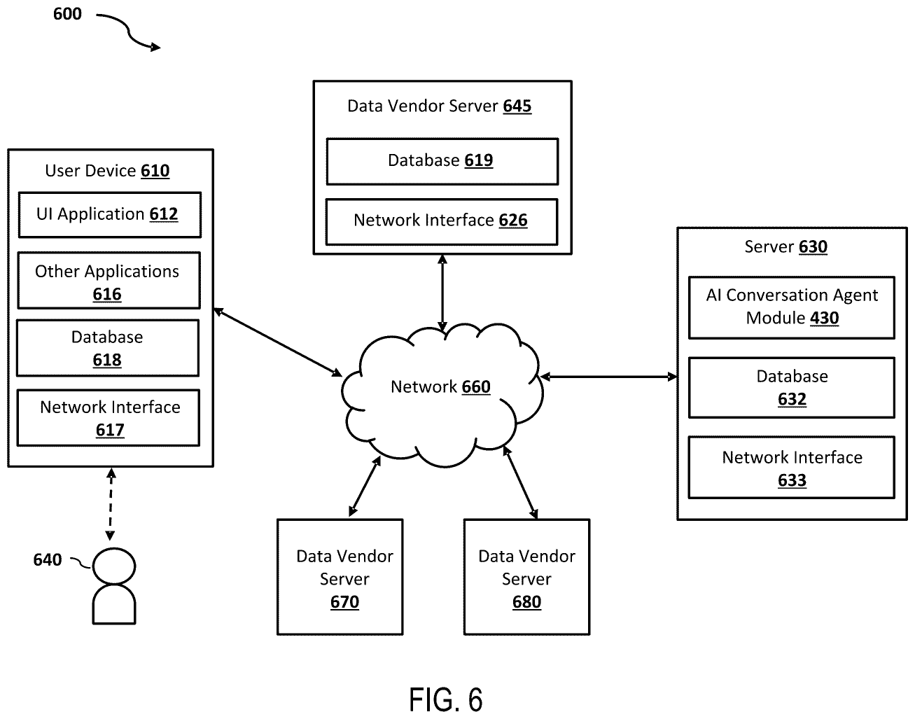

FIG. 6 is a simplified block diagram of a networked system 600 suitable for implementing the training framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI conversation agent module 230 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI conversation agent module 230 may generate a response via the process described in FIGS. 1-3. The AI conversation agent module 230 may thus cause a display of a response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the response.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including text data samples to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI conversation agent module 230 and its submodules described in FIG. 2A. In some implementations, AI conversation agent module 230 may receive data from database 619 at the data vendor server 645 via the network 660 to generate a response. The generated response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the AI conversation agent module 230. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

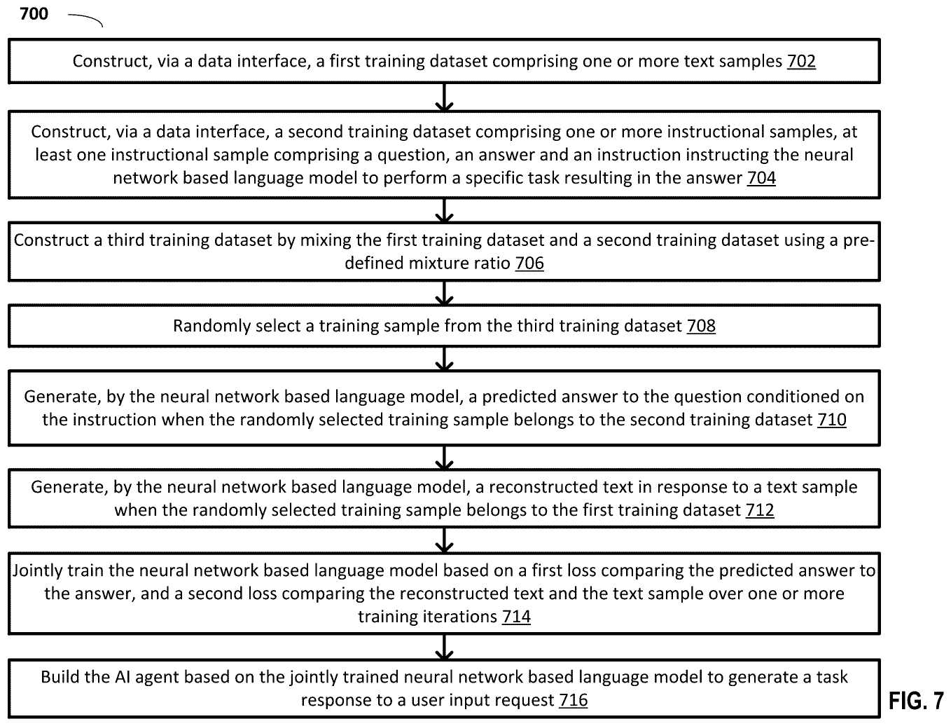

FIG. 7 is an example logic flow diagram illustrating a method of building an artificial intelligence (AI) agent using a neural network based language model using training pipelines shown in FIGS. 1-3B, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI chat agent module 430 (e.g., FIGS. 4 and 5) that performs training and building an AI conversation agent.

In some embodiments, method 700 is performed by a system such as computing device 400, user device 510, server 530, or another device or combination of devices. Inputs (e.g., a user query) may be received via a data interface such as data interface 415, network interface 617, network interface 633, or via a data interface that is integrated with a device. For example, UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a first training dataset (e.g., for CPT) comprising one or more text samples may be constructed via a data interface (e.g., 415 in FIG. 4, 633 in FIG. 6). For example, the one or more text samples comprise at least one domain-specific text and at least one non-domain specific text.

At step 704, a second training dataset (e.g., for IT) comprising one or more instructional samples, at least one instructional sample comprising a question, an answer and an instruction instructing the neural network based language model to perform a specific task resulting in the answer, may be constructed. For example, the one or more instructional samples comprise at least one instructional sample relating to a domain-specific task, and at least one instructional sample relating to a non-domain specific task.

At step 706, a third training dataset may be constructed by mixing the first training dataset and a second training dataset using a pre-defined mixture ratio, e.g., 50% CPT and 50% IT.

At step 708, a training sample may be randomly selected from the third training dataset. For example, the training sample may be drawn to a pre-defined probability.

At step 710, the neural network based language model may generate a predicted answer to the question conditioned on the instruction when the randomly selected training sample belongs to the second training dataset, e.g., IT tuning. For example, the reconstructed text is generated by the neural network based language model to predict one or more masked tokens from the randomly selected training sample.

At step 712, the neural network based language model may generate a reconstructed text in response to a text sample when the randomly selected training sample belongs to the first training dataset, e.g., CPT training.

At step 714, the neural network based language model may be jointly trained based on a first loss comparing the predicted answer to the answer, and a second loss comparing the reconstructed text and the text sample over one or more training iterations. For example, the neural network based language model is updated based on a weighted sum of the first loss from a first training iteration and the second loss from a second training iteration, or alternately updated based on the first loss or the second loss over the one or more training iterations.

At step 716, the AI agent may be built based on the jointly trained neural network based language model to generate a task response to a user input request. For example, the user input request comprises an unseen task prompt not included in the first training dataset or the second training dataset.

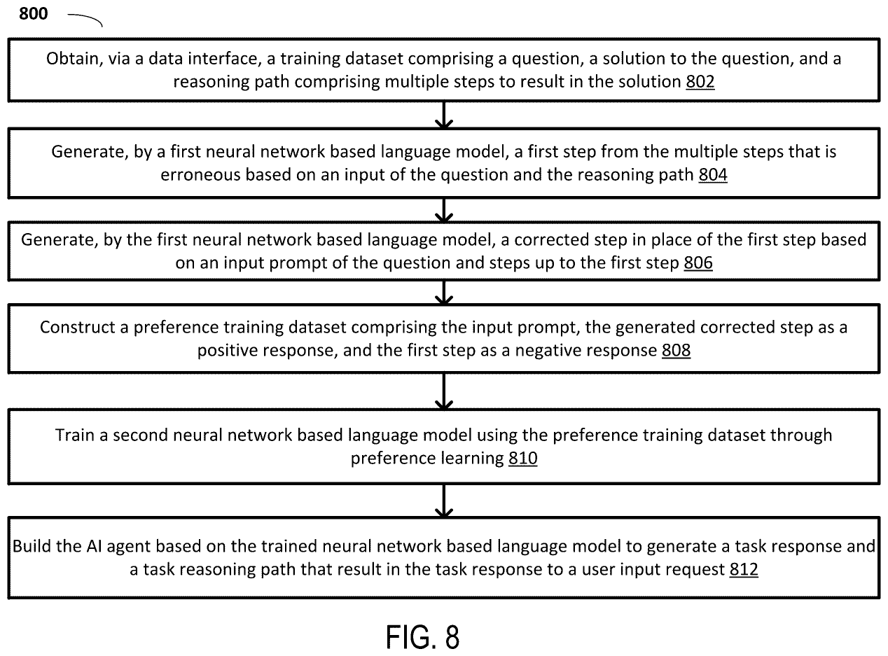

FIG. 8 is an example logic flow diagram illustrating a method of building an artificial intelligence (AI) agent using a neural network based language model using training pipelines shown in FIGS. 1-3, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI chat agent module 430 (e.g., FIGS. 4 and 5) that performs training and building an AI conversation agent.

In some embodiments, method 800 is performed by a system such as computing device 400, user device 510, server 530, or another device or combination of devices. Inputs (e.g., a user query) may be received via a data interface such as data interface 415, network interface 617, network interface 633, or via a data interface that is integrated with a device. For example, UI Application 612 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, a training dataset comprising a question (e.g., 302 in FIG. 3B), a solution (e.g., 304 in FIG. 3B) to the question, and a reasoning path (e.g., 306 in FIG. 3A) comprising multiple steps to result in the solution may be obtained, via a data interface. For example, the reasoning path is generated by the first neural network based language model based on an input of the question and the solution.

At step 804, a first neural network based language model may generate a first step (e.g., 313b in FIG. 3B) from the multiple steps that is erroneous based on an input of the question and the reasoning path.

At step 806, the first neural network based language model may generate a corrected step (e.g., 313a in FIG. 3B) in place of the first step based on an input prompt of the question and steps up to the first step. Alternatively, for example, the first neural network based language model may generate a binary decision indicating whether the solution is accurate, and thus construct another preference training dataset comprising the question, a positive sample of the solution that is determined to be accurate, or a negative sample of the solution that is determined to be inaccurate.

At step 808, a preference training dataset may constructed, comprising the input prompt (e.g., 312 in FIG. 3B), the generated corrected step (e.g., 313a in FIG. 3B) as a positive sample, and the first step (e.g., 313b in FIG. 3B) as a negative sample.

At step 810, a second neural network based language model may be trained using the preference training dataset through preference learning. For example, the second neural network based language model is trained based on a preference loss that maximizes a difference between a first model-generated logit corresponding to the positive sample, and a second model-generated logit corresponding to the negative sample.

At step 812, the AI agent may be built based on the trained neural network based language model to generate a task solution and a task reasoning path that result in the task solution to a user input request.

In one embodiment, embodiments may be applicable in a variety of applications. For example, the task request (e.g., 106 in FIG. 1) received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing the training framework, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing the training framework at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). With improved training framework shown in FIG. 1-8, the neural network based language model may be trained to generate answers with improved accuracy and reasoning paths, so as to execute a task request with improved results.

In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Data Experiments

Example training procedure may be implemented below. For example, pretrained LLM 110 may comprise Llama3-8b-instruct that is adapted with finance data. For first stage of CPT and IT 222, dataset 212 may comprise 50% CPT and 50% IT training samples. For instance, the dataset 212 may comprise CPT: 50% Domain-specific Text (Web and book), 50% General text (verfiable text), IT: 20% Domain-specific tasks, 80% General tasks. For another example, the dataset 212 may comprise CPT: 50% Domain-specific Text (Web and book), 50% General text (verfiable text),+domain-specific books, IT: 20% Domain-specific tasks, 80% General tasks+Exercises extracted from books. For CPT, full attention with cross-document attention masking may be adopted, and for IT, full attention with instruction mask-out and cross-document attention masking may be adopted. The first stage 222 may train the LLM 110 on 16 A100 GPUs. At the second stage of PA 224, a modified DPO loss with an additional negative log-likelihood term may be adopted. The resulting finance-domain adapted LLM 230 may be referred to as Llama-Fin.

Performance of Llama-Fin may be compared with a wide range of baselines models, including its base model, Llama3-8B-instruct, and the 8B peer, Llama3.1-8B-instruct, models of other sizes, such as Phi-3.5-mini-instruct (described in Abdin et al., Phi-3 Technical Report: A Highly Capable Language Model Locally on Your Phone. arXiv:2404.14219, 2024), and Mistral-Nemo-instruct (described in Jiang et al., Mistral 7B. arXiv preprint arXiv:2310.06825, 2023), as well as GPT-4o; and additionally, finance-specific LLM, Palmyra-Fin-32k, which is also based on the Llama3-8B-instruct model.

Table 1 shows the evaluation of Llama-Fin across all considered benchmarks. Scores are reported using the metrics specified in parentheses, ensuring consistency with the corresponding literature. Higher scores always indicate better performance.

TABLE 1
Performance of Llama-Fin

| | | | | | | | |
|---|---|---|---|---|---|---|---|
| | | | | Llama-Fin | | Llamas3 | Llama3.1 |
| Capability | Domain | Task | Benchmark | 8B | CPT + IT 8B | Instruct 8B | Instruct 8B |

Unseen - Similar

| | | | | | | | |
|---|---|---|---|---|---|---|---|
| Tasks | Finance | Sentiment Analysis | FPB (Acc) | 91.13⁺ | 92.99 | 73.09 | 71.55 |
| | | Sentiment Analysis | FiQA SA (Acc) | 95.32⁺ | 94.47 | 77.87 | 70.64 |
| | | Monetary Policy Stance | FOMC (Acc) | 64.31⁺ | 63.10 | 56.65 | 54.64 |
| | | Named Entity Recognition | NER (Rouge1) | 76.69⁺ | 74.33 | 45.03 | 51.22 |
| | | Abstractive Summarization | EDTSUM (Rouge1) | 53.78⁺ | 54.21 | 11.50 | 12.53 |

Unseen - Novel

| | | | | | | | |
|---|---|---|---|---|---|---|---|
| Concept | General | Knowledge Recall | MMLU (CoT, Acc) | 47.42 | 47.22 | 48.14 | 47.42 |
| | | | AI2-ARC (CoT, Acc) | 89.43⁺ | 88.95 | 89.29 | 89.80 |
| | | | Nq-open (CoT, Acc) | 19.20⁺ | 16.20 | 18.47 | 22.52 |
| | Finance | Knowledge Recall | MMLU-Finance (Acc) | 64.20 | 63.93 | 65.71 | 66.74 |
| Task | Finance | Extractive Summarization | Flare-ECTSUM(Rouge1) | 34.10 | 34.41 | 35.92 | 35.77 |
| | | ESG Issue Classification | MLESG (Acc) | 40.67⁺ | 42.00 | 36.33 | 36.00 |
| | | Rumor Detection | MA (Acc) | 84.00⁺ | 84.60 | 82.60 | 84.20 |
| | | Stock Movement Prediction | SM-Bigdata (CoT, Acc) | 54.14 | 52.04 | 55.3 | 46.06 |
| | | | SM-ACL (CoT, Acc) | 51.99⁺ | 49.89 | 50.51 | 45.30 |
| | | | SM-CIKM (CoT, Acc) | 54.94 | 44.88 | 55.56 | 48.03 |
| | | Fraud Detection | CRA-CCF (CoT, Mcc) | 0.83⁺ | 0.61 | −0.32 | 2.73 |
| | | | CRA-CCFraud (CoT, Acc) | 34.03⁺ | 32.32 | 14.78 | 17.3 |
| | | Credit Scoring | Flare-German (CoT, Acc) | 64.00⁺ | 60.50 | 33.50 | 15.00 |
| | | | Flare-Astralian (CoT, Acc) | 44.60 | 51.80 | 66.91 | 11.51 |
| | | | CRA-LendingClub (CoT, Acc) | 68.49⁺ | 65.96 | 52.69 | 25.38 |
| | | Distress Identification | CRA-Polish (CoT, Mcc) | 15.30⁺ | 0.65 | 12.37 | 15.07 |
| | | | CRA-Taiwan (CoT, Acc) | 40.81⁺ | 96.41 | 12.01 | 35.97 |
| | | Claim Analysis | CRA-ProroSeguro (CoT, Acc) | 35.14 | 86.57 | 96.98 | 44.33 |
| | | | CRA-TravelInsurance (CoT, Acc) | 41.52⁺ | 98.50 | 6.39 | 80.31 |
| | | Tabular QA | *Flare-TATQA(CoT, Acc) | 66.61⁺ | 66.43 | 67.80 | 63.70 |
| | | Open QA | *Finance Bench (CoT, Acc) | 54.00⁺ | 52.00 | 52.70 | 38.00 |
| IF/Chat | General | Precise IF | MT-bench (1, 2 turn avg) | 7.36 | 7.29 | 7.88 | 7.92 |
| Reasoning | Math | Math Reasoning | MathQA (CoT, Acc) | 55.08⁺ | 54.30 | 51.16 | 49.35 |
| | General | Social Reasoning | Social-IQA (CoT, Acc) | 75.23⁺ | 73.64 | 68.83 | 70.73 |
| | | Common Sense Reasoning | Open-book-qa (CoT, Acc) | 82.60⁺ | 79.20 | 77.00 | 82.20 |
| | | | Hellaswag (CoT, Acc) | 81.90⁺ | 78.92 | 73.34 | 69.10 |
| | | | Winogrande (CoT, Acc) | 70.32⁺ | 67.48 | 62.51 | 66.69 |
| | | | PIQA (CoT, Acc) | 85.85⁺ | 84.39 | 79.82 | 81.45 |
| | Finance | Exam | CFA-Easy (CoT, Acc) | 66.28⁺ | 62.31 | 60.56 | 60.47 |
| | | | CFA-Challnge (CoT, Acc) | 55.56⁺ | 35.56 | 34.44 | 35.56 |

| | | | | | | Mistral | |
|---|---|---|---|---|---|---|---|
| | | | | | Phi 3.5-mini | Nemo | |
| | | | | Palmyra | Instruct | instruct | |
| Capability | Domain | Task | Benchmark | Fin 70B | 3.8B | 12B | GPT4o |
| Unseen - Similar | | | | | | | |
| Tasks | Finance | Sentiment Analysis | FPB (Acc) | 67.11 | 78.04 | 78.25 | 82.16 |
| | | Sentiment Analysis | FiQA SA (Acc) | 71.91 | 69.36 | 55.74 | 68.51 |
| | | Monetary Policy Stance | FOMC (Acc) | 63.10 | 58.47 | 57.86 | 67.94 |
| | | Named Entity Recognition | NER (Rouge1) | 54.29 | 39.37 | 49.84 | 43.02 |
| | | Abstractive Summarization | EDTSUM (Rouge1) | 21.77 | 19.97 | 12.32 | 18.15 |
| Unseen - Novel | | | | | | | |
| Concept | General | Knowledge Recall | MMLU (CoT, Acc) | 54.93 | 45.07 | 49.64 | 63.88 |
| | | | AI2-ARC (CoT, Acc) | 89.01 | 87.25 | 88.19 | 97.85 |
| | | | Nq-open (CoT, Acc) | 19.25 | 6.20 | 17.01 | 27.92 |
| | Finance | Knowledge Recall | MMLU-Finance (Acc) | 75.15 | 68.17 | 61.88 | 86.52 |
| Task | Finance | Extractive Summarization | Flare-ECTSUM(Rouge1) | 33.24 | 35.52 | 37.86 | 35.90 |
| | | ESG Issue Classification | MLESG (Acc) | 39.67 | 38.33 | 32.67 | 45.67 |
| | | Rumor Detection | MA (Acc) | 62.60 | 75.40 | 85.20 | 73.80 |
| | | Stock Movement Prediction | SM-Bigdata (CoT, Acc) | 48.70 | 53.26 | 53.53 | 49.18 |
| | | | SM-ACL (CoT, Acc) | 51.21 | 49.84 | 50.75 | 50.97 |
| | | | SM-CIKM (CoT, Acc) | 52.92 | 50.03 | 53.28 | 49.78 |
| | | Fraud Detection | CRA-CCF (CoT, Mcc) | 3.12 | 1.20 | 3.94 | 6.16 |
| | | | CRA-CCFraud (CoT, Acc) | 33.03 | 45.33 | 32.94 | 49.57 |
| | | Credit Scoring | Flare-German (CoT, Acc) | 12.00 | 49.50 | 32.50 | 17.00 |
| | | | Flare-Astralian (CoT, Acc) | 12.95 | 46.76 | 56.12 | 51.80 |
| | | | CRA-LendingClub (CoT, Acc) | 23.40 | 48.87 | 21.03 | 65.03 |
| | | Distress Identification | CRA-Polish (CoT, Mcc) | 13.78 | 69.14 | 11.18 | 17.38 |
| | | | CRA-Taiwan (CoT, Acc) | 52.58 | 69.96 | 57.88 | 8.57 |
| | | Claim Analysis | CRA-ProroSeguro (CoT, Acc) | 56.20 | 25.86 | 32.58 | 96.60 |
| | | | CRA-TravelInsurance (CoT, Acc) | 17.28 | 94.48 | 73.64 | 54.03 |
| | | Tabular QA | *Flare-TATQA(CoT, Acc) | 64.21 | 57.70 | 66.40 | 74.90 |
| | | Open QA | *Finance Bench (CoT, Acc) | 56.67 | 40.70 | 53.30 | 51.30 |
| IF/Chat | General | Precise IF | MT-bench (1, 2 turn avg) | 5.80 | 8.38 | 7.84 | 9.10 |
| Reasoning | Math | Math Reasoning | MathQA (CoT, Acc) | 41.51 | 39.40 | 52.46 | 70.82 |
| | General | Social Reasoning | Social-IQA (CoT, Acc) | 77.28 | 72.82 | 62.95 | 78.92 |
| | | Common Sense Reasoning | Open-book-qa (CoT, Acc) | 87.00 | 80.20 | 76.40 | 94.60 |
| | | | Hellaswag (CoT, Acc) | 69.69 | 67.89 | 61.74 | 81.76 |
| | | | Winogrande (CoT, Acc) | 74.27 | 72.22 | 65.82 | 85.71 |
| | | | PIQA (CoT, Acc) | 86.72 | 82.05 | 77.91 | 94.34 |
| | Finance | Exam | CFA-Easy (CoT, Acc) | 36.05 | 61.24 | 65.89 | 83.14 |
| | | | CFA-Challnge (CoT, Acc) | 25.56 | 48.89 | 43.33 | 74.44 |

Unseen-Similar. Llama-Fin trained based on Llama-3-8b-instruct outperforms all other baselines in its size category. It also surpasses significantly larger models, such as the finance-specific Palmyra-Fin-32K (70B). Notably, Llama-Fin also exceeds the performance of the closed model GPT-4o. These results demonstrate the effectiveness of our data and model recipe for domain-adaptive post-training.

Unseen-Novel. To evaluate the generalization of Llama-Fin, its performance on unseen novel tasks that correspond to the identified capabilities. Below, the key takeaways is summarized from this comparison:

Llama-Fin Preserves General Concepts. Llama-Fin performs better or remains competitive with its base model in general knowledge recall tasks, indicating that it effectively preserves general concepts. It performs slightly worse than the base model in finance knowledge recall (MMLU-Finance), despite our earlier finding that the CPT benefits IT. Itis hypothesized that CPT helps learn concepts that are helpful but differ from those emphasized in MMLU-Finance.

Llama-Fin is Effective in The Majority of Tasks. Llama-Fin outperforms the base model in 12 out of 17 tasks, demonstrating that our approach can lead to models that generalize well to novel, unseen tasks requiring the same capabilities.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of building an artificial intelligence (AI) agent using a neural network based language model, the method comprising:
constructing, via a data interface, a first training dataset comprising one or more text samples;
constructing, via a data interface, a second training dataset comprising one or more instructional samples, at least one instructional sample comprising a question, an answer and an instruction instructing the neural network based language model to perform a specific task resulting in the answer;
constructing a third training dataset by mixing the first training dataset and a second training dataset using a pre-defined mixture ratio;
randomly selecting a training sample from the third training dataset;
generating, by the neural network based language model, a predicted answer to the question conditioned on the instruction when the randomly selected training sample belongs to the second training dataset;
generating, by the neural network based language model, a reconstructed text in response to a text sample when the randomly selected training sample belongs to the first training dataset;
jointly training the neural network based language model based on a first loss comparing the predicted answer to the answer, and a second loss comparing the reconstructed text and the text sample over one or more training iterations; and
building the AI agent based on the jointly trained neural network based language model to generate a task response to a user input request.

2. The method of claim 1, wherein the one or more text samples comprise at least one domain-specific text and at least one non-domain specific text.

3. The method of claim 1, wherein the one or more instructional samples comprise at least one instructional sample relating to a domain-specific task, and at least one instructional sample relating to a non-domain specific task.

4. The method of claim 1, wherein the reconstructed text is generated by the neural network based language model to predict one or more masked tokens from the randomly selected training sample.

5. The method of claim 1, wherein the neural network based language model is updated based on a weighted sum of the first loss from a first training iteration and the second loss from a second training iteration.

6. The method of claim 1, wherein the neural network based language model is alternately updated based on the first loss or the second loss over the one or more training iterations.

7. The method of claim 1, wherein the user input request comprises an unseen task prompt not included in the first training dataset or the second training dataset.

8. The method of claim 1, further comprising:
after the joint training:
obtaining training data comprising a question, a solution to the question, and a reasoning path comprising multiple steps to result in the solution;
generating, by the neural network based language model, a first step from the multiple steps that is erroneous based on an input of the question and the reasoning path;
generating, by the first neural network based language model, a corrected step in place of the first step based on an input prompt of the question and steps up to the first step;
constructing a preference training dataset comprising the input prompt, the generated corrected step as a positive response, and the first step as a negative response; and
training the neural network based language model using the preference training dataset through preference learning.

9. A system of building an artificial intelligence (AI) agent using a neural network based language model, the system comprising:
a data interface constructing a first training dataset comprising one or more text samples and a second training dataset comprising one or more instructional samples, at least one instructional sample comprising a question, an answer and an instruction instructing the neural network based language model to perform a specific task resulting in the answer;
a memory storing a plurality of processor-executable instructions; and
one or more processors executing the plurality of processor-executable instructions to perform operations comprising:
constructing a third training dataset by mixing the first training dataset and a second training dataset using a pre-defined mixture ratio;
randomly selecting a training sample from the third training dataset;
generating, by the neural network based language model, a predicted answer to the question conditioned on the instruction when the randomly selected training sample belongs to the second training dataset;
generating, by the neural network based language model, a reconstructed text in response to a text sample when the randomly selected training sample belongs to the first training dataset;
jointly training the neural network based language model based on a first loss comparing the predicted answer to the answer, and a second loss comparing the reconstructed text and the text sample over one or more training iterations; and
building the AI agent based on the jointly trained neural network based language model to generate a task response to a user input request.

10. The system of claim 9, wherein the one or more text samples comprise at least one domain-specific text and at least one non-domain specific text.

11. The system of claim 9, wherein the one or more instructional samples comprise at least one instructional sample relating to a domain-specific task, and at least one instructional sample relating to a non-domain specific task.

12. The system of claim 9, wherein the reconstructed text is generated by the neural network based language model to predict one or more masked tokens from the randomly selected training sample.

13. The system of claim 9, wherein the neural network based language model is updated based on a weighted sum of the first loss from a first training iteration and the second loss from a second training iteration.

14. The system of claim 9, wherein the neural network based language model is alternately updated based on the first loss or the second loss over the one or more training iterations.

15. The system of claim 9, wherein the user input request comprises an unseen task prompt not included in the first training dataset or the second training dataset.

16. The system of claim 9, wherein the operations further comprise:
after the joint training:
obtaining training data comprising a question, a solution to the question, and a reasoning path comprising multiple steps to result in the solution;
generating, by the neural network based language model, a first step from the multiple steps that is erroneous based on an input of the question and the reasoning path;
generating, by the first neural network based language model, a corrected step in place of the first step based on an input prompt of the question and steps up to the first step;
constructing a preference training dataset comprising the input prompt, the generated corrected step as a positive response, and the first step as a negative response; and
training the neural network based language model using the preference training dataset through preference learning.

17. A non-transitory processor-readable medium storing a plurality of processor-executable instructions for building an artificial intelligence (AI) agent using a neural network based language model, the instructions executable by one or more processors to perform operations comprising:
constructing, via a data interface, a first training dataset comprising one or more text samples;
constructing, via a data interface, a second training dataset comprising one or more instructional samples, at least one instructional sample comprising a question, an answer and an instruction instructing the neural network based language model to perform a specific task resulting in the answer;
constructing a third training dataset by mixing the first training dataset and a second training dataset using a pre-defined mixture ratio;
randomly selecting a training sample from the third training dataset;
generating, by the neural network based language model, a predicted answer to the question conditioned on the instruction when the randomly selected training sample belongs to the second training dataset;
generating, by the neural network based language model, a reconstructed text in response to a text sample when the randomly selected training sample belongs to the first training dataset;
jointly training the neural network based language model based on a first loss comparing the predicted answer to the answer, and a second loss comparing the reconstructed text and the text sample over one or more training iterations; and
building the AI agent based on the jointly trained neural network based language model to generate a task response to a user input request.

18. The non-transitory processor-readable medium of claim 17, wherein the one or more text samples comprise at least one domain-specific text and at least one non-domain specific text.

19. The non-transitory processor-readable medium of claim 17, wherein the one or more instructional samples comprise at least one instructional sample relating to a domain-specific task, and at least one instructional sample relating to a non-domain specific task.

20. The non-transitory processor-readable medium of claim 17, wherein the neural network based language model is updated based on a weighted sum of the first loss from a first training iteration and the second loss from a second training iteration, or is alternately updated based on the first loss or the second loss over the one or more training iterations.
